(19) United States
(12) Patent Application Publication
(10) Pub. No.: US 2026/0212761 A1
(43) Pub. Date: Jul. 23, 2026

(54) METHOD AND SYSTEM FOR WARNING OF COLLISION RISK WITH A DYNAMIC OBJECT IN ALL DIRECTIONS AROUND AN EGO VEHICLE

(71) Applicants: HYUNDAI MOTOR COMPANY, Seoul (KR); KIA CORPORATION, Seoul (KR)

(72) Inventors: Jung-Hun Choi, Hwaseong-si (KR); Dong-Chul Lee, Hwaseong-si (KR); In-Soo Jung, Hwaseong-si (KR); Jae-Min Jin, Hwaseong-si (KR); Kyoung-Jin Noh, Hwaseong-si (KR)

(73) Assignees: HYUNDAI MOTOR COMPANY, Seoul (KR); KIA CORPORATION, Seoul (KR)

(21) Appl. No.: 19/251,239

(22) Filed: Jun. 26, 2025

(30) Foreign Application Priority Data
Jan. 23, 2025 (KR) 10-2025-0010552

(51) Int. Cl. G08G 1/16; B60W 30/09

(52) U.S. Cl. CPC G08G 1/166; B60W 30/09; B60W 2554/4041; B60W 2554/4042

(57) ABSTRACT

A method and system for estimating collision risk in real time by incorporating vehicle turning information and braking distance into driving information of an ego vehicle and the position and speed of a dynamic object is disclosed. The collision risk is estimated using a collision probability density function based on a time delay. The collision risk is calculated in real time based on the initial position measured by UWB (ultra-wideband) sensors or GPS of the ego vehicle and the dynamic object, as well as the relative position over time.

### CROSS-REFERENCE TO RELATED APPLICATION

This application claims priority to Korean Patent Application No. 10-2025-0010552, filed on Jan. 23, 2025, which is incorporated herein by reference in its entirety.

### BACKGROUND

### Technical Field

Embodiments of the present disclosure relate to a method and system for warning of a collision risk with a dynamic object in all directions around an ego vehicle and, more particularly, to estimating a collision risk in real time using UWB (ultra-wideband) sensors.

### Description of Related Art

Collisions between pedestrians and ego vehicles (e.g., vehicles controlled by an autonomous driving system) occurring in all directions are one of the major causes of traffic accident fatalities and injuries. Particularly in urban environments, collision risks tend to increase because vehicles and pedestrians coexist in confined spaces. Frequent situations occur where a driver's view is limited at intersections or curved roads, or where pedestrians are detected late. In addition, the risk of unintentional collisions increases in blind spots, aside from the fact that pedestrians may not be fully aware of their surroundings when using smartphones or wearing earphones.

Traditionally, sensor-based assistance systems using radar, LiDAR, and/or cameras have been utilized to detect pedestrians. However, these technologies have limitations in accuracy in adverse weather conditions such as rain or fog, or in complex road environments. Visual or auditory warning systems inside the vehicle have limited effectiveness when the driver's reaction time is insufficient. Automatic emergency braking systems are installed in some premium vehicles to assist in collision prevention, but these systems have technical limitations and do not function perfectly in all situations.

### SUMMARY OF THE DISCLOSURE

To reduce vehicle-pedestrian collisions in blind spots, advanced sensor technology is required to precisely determine a pedestrian's position and trajectory. Additionally, a method or system is required to predict the potential for collisions between vehicles and pedestrians in real time and prevent accidents.

Various embodiments are directed to providing a method for position estimation to avoid collisions by calculating a vehicle collision risk area based on vehicle data, such as driving information, including the vehicle's speed, acceleration, braking distance, steering angle, and heading direction.

A method for warning of a collision risk with a dynamic object in all directions around an ego vehicle includes estimating collision risk in real time by incorporating vehicle turning information into driving information of the ego vehicle and the position of the dynamic object and the speed of the dynamic object. The collision risk is estimated in real time using a collision probability density function and a collision probability area, considering (i.e., based on) a time delay.

In addition, the collision risk may be determined in real time based on an initial position of the ego vehicle and the dynamic object measured by UWB (ultra-wideband) sensors installed in the ego vehicle, as well as a relative position over time.

In addition, the turning information of the ego vehicle includes a steering angle based on an Ackermann model. The real-time estimated collision risk may be based on a braking distance of the vehicle, and the braking distance may be a quadratic function of the ego vehicle's speed.

In addition, the position of the dynamic object and the speed of the dynamic object may be estimated based on a Kalman filter. A data-drop compensation of the dynamic object may be based on an action radius of the dynamic object and a maximum speed limit of the dynamic object.

In addition, the distance from the center of the dynamic object to an edge of the dynamic object may be shifted in the collision probability density function, considering a width of the dynamic object and a length of the dynamic object.

In addition, the collision probability density function and the collision probability area calculations may include a time delay, and the time delay may be a communication delay or a driver delay.

A system for warning of a collision risk with a dynamic object in all directions around an ego vehicle includes a positioning sensor installed in the ego vehicle and configured to sense the position of the ego vehicle and the dynamic object. The collision risk is estimated in real time using the positioning sensor by incorporating vehicle turning information into driving information of the ego vehicle and a position of the dynamic object and a speed of the dynamic object.

The collision risk is estimated in real time using a collision probability density function and a collision probability area, considering a time delay.

In addition, the positioning sensor is a UWB sensor. The estimated collision risk may be further based on a braking distance of the ego vehicle, and the braking distance may be a quadratic function of a speed of the ego vehicle.

With the method and system for warning of collision risk with a dynamic object in all directions around an ego vehicle, preemptive detection of a dynamic object, including a pedestrian beyond obstacles, and risk analysis are performed, which enables warnings related to blind spots in all directions. In particular, by utilizing the UWB digital key system installed in the vehicle, preemptive detection of a dynamic object and omnidirectional risk warnings are performed without the need for additional sensors. This system may be extended to vehicle-to-vehicle or vehicle-to-pedestrian applications and run as an algorithm even on microcontroller units (MCUs), which are low-cost microprocessors used in digital key systems.

### BRIEF DESCRIPTION OF THE DRAWINGS

FIG. 1 is an illustration of a situation where a vehicle collision is preemptively detected in a blind spot beyond an obstacle, according to an embodiment of the present disclosure.

FIG. 2 is a block diagram of a collision warning system for a dynamic object in all directions around an ego vehicle according to an embodiment of the present disclosure.

FIG. 3A is an illustration of a potential collision venue based on information of a vehicle and a pedestrian. FIG. 3B is an illustration of an application of vehicle turning to the calculation of the potential collision venue.

FIG. 4 is an illustration of an interaction between a pedestrian and a vehicle, segmented over time.

FIG. 5 is an illustration of a turning equation for a vehicle turning along a curved path.

FIG. 6A is an illustration incorporating characteristics of a pedestrian's action radius into risk analysis, according to an embodiment of the present disclosure. FIG. 6B is an illustration incorporating a movement area, considering the physical width/length of a dynamic object, into the risk analysis, according to an embodiment of the present disclosure.

### DETAILED DESCRIPTION

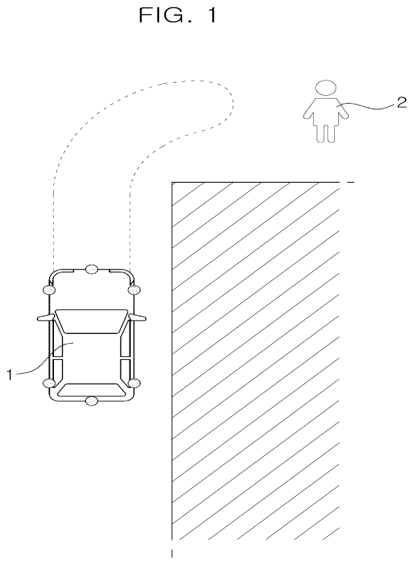

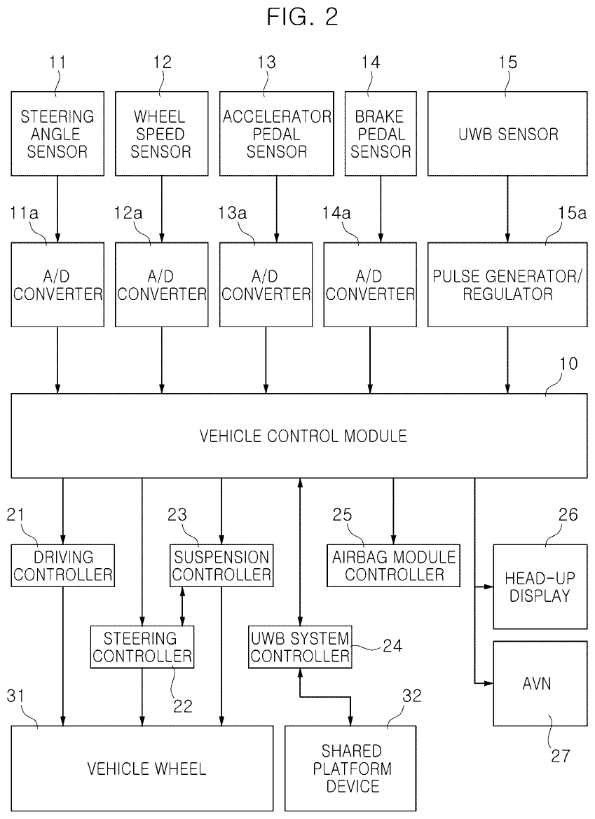

FIG. 1 is an illustration of a situation where a vehicle collision is preemptively detected by a positioning sensor, especially an ultra-wideband (UWB) sensor or GPS, in a blind spot beyond an obstacle. FIG. 2 is a block diagram of a collision warning system for a dynamic object in all directions around an ego vehicle according to an embodiment of the present disclosure.

A collision warning system for a dynamic object in all directions around an ego vehicle according to the present disclosure is operated by a vehicle control module 10, which controls the driving of the vehicle.

When information about the state of a vehicle 1 or a dynamic object 2, including a pedestrian, is input to the vehicle control module 10, the vehicle control module 10 determines whether the dynamic object 2 is present in all directions around the vehicle 1 based on pre-stored logic. When the distance between the vehicle 1 and the dynamic object 2 decreases or a collision is estimated, this vehicle control module 10 warns a driver of the vehicle 1. The warning may be a message or image displayed to an occupant of the vehicle 1, such as the driver, via an HUD (Head-Up Display) 26, an AVN (Audio, Video, Navigation) device 27, or an augmented reality device (not illustrated), such as glasses, worn by the occupant. In some embodiments, the warning may be an audible sound played by speakers in the vehicle 1 or vibrations in seats of the vehicle 1.

A steering angle sensor 11 detects a steering angle at which the driver operates the steering wheel of the vehicle 1, converts the detected angle into a digital signal through an A/D converter 11a, and outputs the digital signal to the vehicle control module 10. The steering angle detected by the steering angle sensor 11 is differentiated with respect to time to calculate the steering speed.

A wheel speed sensor 12 detects the speed of the vehicle 1 and outputs the detected speed to the vehicle control module 10 through an A/D converter 12a. By doing so, the vehicle control module 10 detects the speed of the vehicle 1. The speed may also be detected through an AVN (Audio, Video, Navigation) device 27 of the vehicle 1 and input to the vehicle control module 10.

An accelerator pedal sensor 13 detects and outputs an amount of operation of the accelerator pedal when the driver operates the accelerator pedal to accelerate the vehicle 1.

A brake pedal sensor 14 detects and outputs an amount of operation of the brake pedal when the driver operates the brake pedal to decelerate the vehicle 1.

The output values of the accelerator pedal sensor 13 and the brake pedal sensor 14 pass through A/D converters 13a and 14a, respectively, and are input to the vehicle control module 10.

A UWB sensor 15 detects a position of a dynamic object 2, including the vehicle 1 and a pedestrian 2.

When the dynamic object 2 around the vehicle 1 is detected or a collision is estimated, the vehicle control module 10 controls the behavior of the vehicle 1. The vehicle control module 10 utilizes a driving controller 21, a steering controller 22, and a suspension controller 23 to control the behavior of the vehicle 1. To achieve this, bidirectional communication is performed directly between the steering controller 22 and the suspension controller 23.

When the driving controller 21, the steering controller 22, and the suspension controller 23 operate, the results of their control are applied to the vehicle's wheels.

A UWB system controller 24 performs signal processing, channel management, and power control of the UWB sensor to maintain consistent performance. The UWB system controller 24 may estimate the positions between the UWB sensors of the ego vehicle 1 and the dynamic object 2 and transmit and receive signals via bidirectional communication with a shared platform device 32.

When the vehicle control module 10 determines that a collision between the vehicle 1 and the dynamic object 2 is inevitable, an airbag module controller 25 deploys airbags installed in the vehicle 1 to protect the driver of the vehicle 1 and passengers.

In addition, the vehicle control module 10 displays the direction and position of the dynamic object 2 on a HUD (Head-Up Display) 26, the AVN 27, or an augmented reality device (not illustrated) worn by the driver as glasses.

The HUD 26, the AVN 27, and the augmented reality device display the direction and distance of the dynamic object from the vehicle 1 using indicators and arrows. For example, the arrow points to the current position of the dynamic object 2. The distance between the vehicle 1 and the dynamic object 2 may be represented by varying the color of the arrow based on the distance between the vehicle 1 and the dynamic object 2. For example, as the distance between the vehicle 1 and the dynamic object 2 decreases, the color of the arrow may be displayed as changing from green to orange and then to red.

A vehicle collision risk area may be calculated based on vehicle data such as driving information, including the vehicle's speed, acceleration, braking distance, steering angle, and heading direction.

The collision risk area dynamically changes based on real-time speed variation and turning radius of the vehicle 1. The current speed and position of the pedestrian 2 are combined with the vehicle's driving data to analyze the potential for a collision in real time. This allows for estimating when the vehicle 1 and the pedestrian 2 enter the danger zone and notifying the driver in real time.

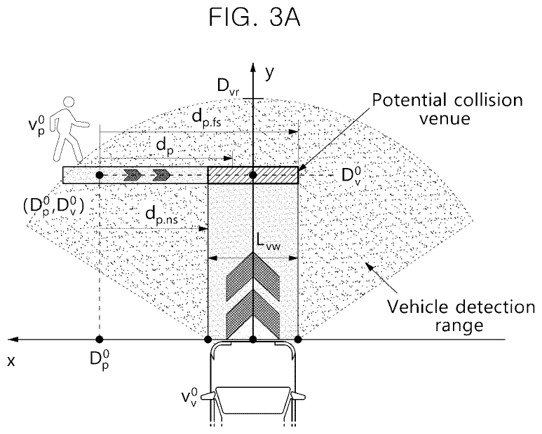

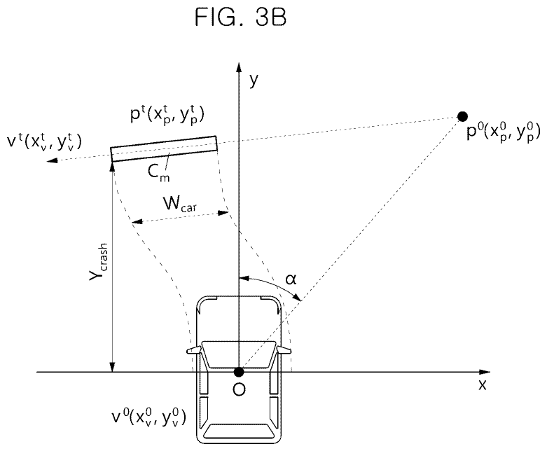

In FIG. 3A, a potential collision venue is an area where both the vehicle and pedestrian are likely to reach. This is calculated based on factors such as the sensor detection range Dᵥᵣ, the pedestrian's initial speed Vₚ, the pedestrian's lateral position Dₚ relative to the vehicle's width, the nearest position between the pedestrian and the vehicle d_{p.ns}, and the farthest position between the pedestrian and the vehicle d_{p.fs}, along with the vehicle and pedestrian speeds, travel directions, and distances. This area indicates the zone of potential collision risk. The braking distance required for a vehicle to stop at the current speed is calculated to estimate potential collision risks within that distance.

As the vehicle's speed increases, the braking distance becomes longer, and the potential collision venue also increases. Conversely, when the vehicle's speed decreases, the potential collision venue decreases.

In addition, the risk at the potential collision venue changes based on the pedestrian's path and speed, whether the pedestrian is moving quickly, approaching the vehicle diagonally, moving away from the collision venue, or stopping.

FIG. 3B illustrates the potential collision venue when a vehicle turns or drives along a curved path. The potential collision venue may change to a curved shape based on a vehicle's turning radius and direction, which are determined by the Ackermann model.

The Ackermann model is a model used to design a vehicle's steering mechanism, allowing the calculation of the steering angles to ensure that all wheels follow the correct trajectory when the vehicle turns a curve. This is a fundamental geometric model used to design a vehicle's turning motion, enabling the design of a steering mechanism that allows each wheel to follow the optimal path when the vehicle turns a curve.

A probability density function of the positions of the pedestrian and the vehicle is given as f(p⁰) and f(v⁰) at time t₀(t₀=0), as shown in Equations 1 and 2.

$$f ( {p}^{0} ) = \frac{1}{2 π {σ}_{x , p} {σ}_{y , p}} exp ( - \frac{1}{2} [ \frac{{( {x}_{p}^{0} - {μ}_{x , p}^{0} )}^{2}}{{σ}_{x , p}^{2}} + \frac{{( {y}_{p}^{0} - {μ}_{y , p}^{0} )}^{2}}{{σ}_{y , p}^{2}} ] ) \qquad ( Equation 1 )$$

$$f ( {v}^{0} ) = \frac{1}{2 π {σ}_{x , v} {σ}_{y , v}} exp ( - \frac{1}{2} [ \frac{{( {x}_{v}^{0} - {μ}_{x , v}^{0} )}^{2}}{{σ}_{x , v}^{2}} + \frac{{( {y}_{v}^{0} - {μ}_{y , v}^{0} )}^{2}}{{σ}_{y , v}^{2}} ] ) \qquad ( Equation 2 )$$

In Equations 1 and 2, (μ_{x,p0}), (μ_{y,p0}) and (μ_{x,v0}), (μ_{y,v0}) represent the initial positions of the pedestrian and the vehicle obtained from GPS (or UWB sensors), and the initial positions are updated every second (e.g., 1 second). σ²_{x,p}, σ²_{y,p}, σ²_{x,v}, and σ²_{y,v} are the variance values of the initial positions.

Therefore, when transmitting real-time information, required for avoiding an additional collision, using V2P UWB (vehicle-to-pedestrian ultra-wideband) communication, the delay due to communication latency t_{cesta} and t_{commd} and the driver delay due to driver behavior t_{rac} and tᵣₑₛₚ may be included. The delay time caused by communication and response delays, such as t_{cesta}, t_{commd}, t_{reac}, and tᵣₑₛₚ, is referred to as tₜₒₜ.

When the pedestrian reaches the origin O, the actual coordinates of the pedestrian and the vehicle are calculated as shown in Equations 3A-D.

$$c {μ}_{x , {p}^{0}} = {μ}_{x , {p}^{0}} - {v}_{px} ( {t}_{cesta} + {t}_{commd} + {t}_{reac} + {t}_{resp} ) \qquad ( Equation 3 A )$$

$$c {μ}_{y , {p}^{0}} = {μ}_{y , {p}^{0}} - {v}_{py} ( {t}_{cesta} + {t}_{commd} + {t}_{reac} + {t}_{resp} ) \qquad ( Equation 3 B )$$

$$c {μ}_{x , {v}^{0}} = {μ}_{x , {v}^{0}} - {v}_{vx} ( {t}_{cesta} + {t}_{commd} + {t}_{reac} + {t}_{resp} ) \qquad ( Equation 3 C )$$

$$c {μ}_{y , {v}^{0}} = {μ}_{y , {v}^{0}} - {v}_{vy} ( {t}_{cesta} + {t}_{commd} + {t}_{reac} + {t}_{resp} ) \qquad ( Equation 3 D )$$

The pedestrian's x and y velocity components and the vehicle's x and y velocity components are represented by vₚₓ, v_{py}, vᵥₓ, and v_{vy}, respectively.

When Equations 3A-D are substituted into Equations 1 and 2, the positions of the pedestrian and the vehicle are shown in Equations 4A and 4B.

$$( Equation 4 A )$$

$$f ( {cp}^{0} ) = \frac{1}{2 π {σ}_{x , p} {σ}_{y , p}} exp ( - \frac{1}{2} [ \frac{{( {x}_{p}^{0} - c {μ}_{x , {p}^{0}} )}^{2}}{{σ}_{x , p}^{2}} + \frac{{( {y}_{p}^{0} - c {μ}_{y , {p}^{0}} )}^{2}}{{σ}_{y , p}^{2}} ] )$$

$$( Equation 4 B )$$

$$f ( {cv}^{0} ) = \frac{1}{2 π {σ}_{x , v} {σ}_{y , v}} exp ( - \frac{1}{2} [ \frac{{( {x}_{v}^{0} - c {μ}_{x , {v}^{0}} )}^{2}}{{σ}_{x , v}^{2}} + \frac{{( {y}_{v}^{0} - c {μ}_{y , {v}^{0}} )}^{2}}{{σ}_{y , v}^{2}} ] )$$

The probability density functions for the positions of the pedestrian and the vehicle here are f(cp⁰) and f(cv⁰) at the time instance to, respectively. By simplifying certain conditions in Equations 4A and 4B, the same model as described in other studies may be derived.

In addition, after a short time t, the corresponding coordinates of the pedestrian and the vehicle are p^{t}(x^{t}ₚ, y^{t}ₚ) and v^{t}(x^{t}ᵥ, y^{t}ᵥ), respectively, at the time instance (t=t+t₀), as shown in Equations 5A-5D below.

A probability density function for the actual positions of the pedestrian and the vehicle represents the probability distribution of their positions over time and space. As a probability density function in the potential collision venue, the collision risk may be calculated.

When expressed as a collision probability density function, the following applies when the pedestrian reaches the origin O, as shown in Equations 5A-5D.

$$c {μ}_{x , {p}^{0}} = {μ}_{x , {p}^{0}} - {v}_{px} ( {t}_{cesta} + {t}_{commd} + {t}_{reac} + {t}_{resp} + t ) \qquad ( Equation 5 A )$$

$$c {μ}_{y , {p}^{t}} = {μ}_{y , {p}^{0}} - {v}_{py} ( {t}_{cesta} + {t}_{commd} + {t}_{reac} + {t}_{resp} + t ) \qquad ( Equation 5 B )$$

$$c {μ}_{x , {v}^{t}} = {μ}_{x , {v}^{0}} - {v}_{vx} ( {t}_{cesta} + {t}_{commd} + {t}_{reac} + {t}_{resp} + t ) \qquad ( Equation 5 C )$$

$$c {μ}_{y , {v}^{t}} = {μ}_{y , {v}^{0}} - {v}_{vy} ( {t}_{cesta} + {t}_{commd} + {t}_{reac} + {t}_{resp} + t ) \qquad ( Equation 5 D )$$

The probability density functions for the actual positions of the pedestrian and the vehicle at the time instance t are f(cp^{t}) and f(cv^{t}), respectively. Depending on the communication delay and driver behavior delay, the delay time tₜₒₜ is subdivided into communication delays t_{cesta}, t_{commd}, and driver behavior delays t_{reac}, tᵣₑₛₚ. After t seconds from the time instance to, the probability density functions for the actual positions of the pedestrian and the vehicle are represented by Equations 6A and 6B.

$$( Equation 6 A )$$

$$f ( {cp}^{t} ) = \frac{1}{2 π {σ}_{x , p} {σ}_{y , p}} exp ( - \frac{1}{2} [ \frac{{( {x}_{p}^{0} - c {μ}_{x , {p}^{t}} )}^{2}}{{σ}_{x , p}^{2}} + \frac{{( {y}_{p}^{0} - c {μ}_{y , {p}^{t}} )}^{2}}{{σ}_{y , p}^{2}} ] )$$

$$( Equation 6 B )$$

$$f ( {cv}^{t} ) = \frac{1}{2 π {σ}_{x , v} {σ}_{y , v}} exp ( - \frac{1}{2} [ \frac{{( {x}_{p}^{0} - c {μ}_{x , {v}^{t}} )}^{2}}{{σ}_{x , v}^{2}} + \frac{{( {y}_{v}^{0} - c {μ}_{y , {v}^{t}} )}^{2}}{{σ}_{y , v}^{2}} ] )$$

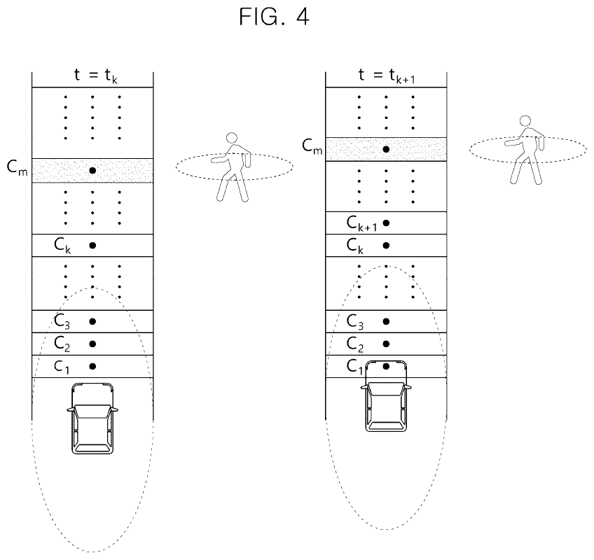

FIG. 4 analyzes the interaction between the pedestrian and the vehicle over time, showing changes in the movement trajectories of the pedestrian and the vehicle over time. The position of Cₘ, the potential collision venue, varies accordingly, along with the probability of a collision.

At time tₖ, the vehicle and the pedestrian are at a position where the vehicle may detect the pedestrian's presence, but the vehicle is positioned away from the potential collision venue. On the other hand, at time tₖ₊₁, the vehicle moves closer to the pedestrian's position and increases the probability of a collision.

When a vehicle is in motion and a pedestrian with a width of W_{ped} approaches from one side, the length of the target road segment is L. Based on the vehicle's path, this road segment may be divided into M=L/W_{pad} subsegments, where M represents the number of subsegments.

From the vehicle's current position, the m-th subsegment Cₘ has x-coordinates from x⁰ₘ (i.e., −½W_{car}) to x¹ₘ (i.e., ½W_{car}), and y-coordinates from y⁰ₘ, i.e., (m−1)*W_{ped}, to yₘ, i.e., m*W_{ped}.

At time tₖ, the probability value p^{tk}_{cm} for the collision risk assessment of Cₘ is calculated by substituting into Equations 6A and 6B, which results in Equation 7. Equation 7 is partially differentiated with respect to the x and y axes using the real-time UWB relative distance between the vehicle and the pedestrian, and the collision probability area is calculated.

$${p}_{{c}_{m}}^{{t}_{k}} = {\int }_{{y}_{m}^{0}}^{{y}_{m}^{l}} {\int }_{{x}_{m}^{0}}^{{x}_{m}^{l}} f ( {cv}^{t} ) \times f ( {cp}^{t} ) {\vert}_{t = {t}_{k}} {d}_{x} {d}_{y} \qquad ( Equation 7 )$$

Based on the Ackermann model, the method of varying the risk area when the vehicle turns may calculate the area by using the turning radii of inner and outer wheels. In particular, based on the steady-state turning equations that incorporates the vehicle's specifications and behavior, detailed modeling is performed by varying the risk area.

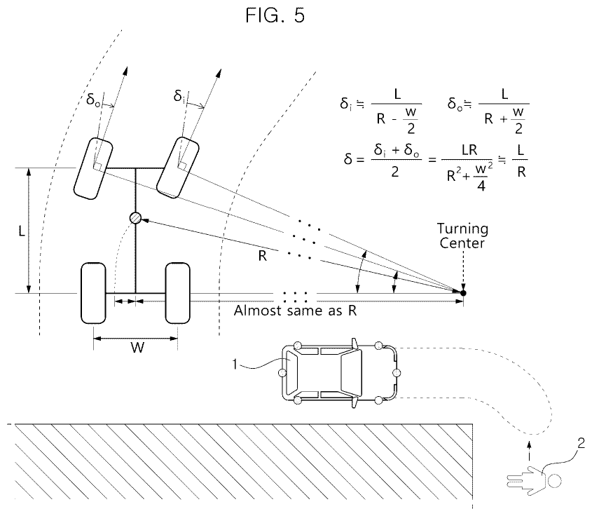

FIG. 5 shows equations for the angle of the front wheels with respect to the turning center, including the steering angles (δ) of inner and outer wheels, the track width (L), and the wheel width (w), as a vehicle turns along a curved path. The vehicle collision risk area may be calculated based on vehicle data with the steering angle added according to the steering input.

In addition, the lateral driving risk area of the vehicle may be varied based on the braking distance corresponding to changes in vehicle speed. As an example, a quadratic function for vehicle speed, V²/100*0.88, may be used to calculate the braking distance.

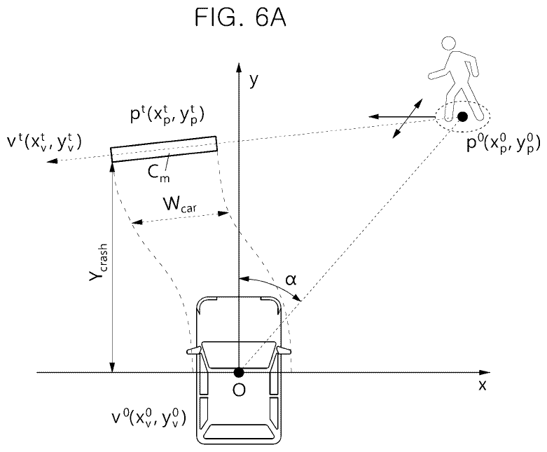

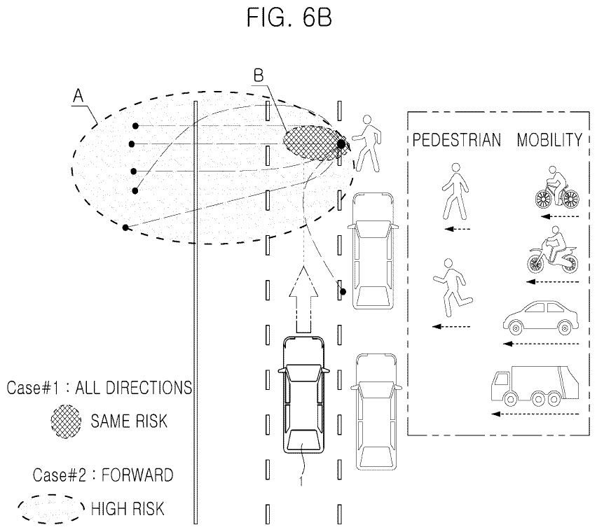

FIG. 6A shows that the characteristics of the pedestrian's action radius may be further considered (i.e., based on) in the risk analysis. In other words, the action radius and maximum speed limit of a dynamic object, including a pedestrian, are considered, and the travel path of a dynamic object, including a pedestrian, is estimated using a Kalman filter. This allows for data-drop compensation for each dynamic object and the estimation of the potential movement path of the dynamic object. As a result, the area of the collision risk zone may change not only into a circle or ellipse, but also into other geometric shapes.

FIG. 6B shows a generated movement area that considers the physical width/length of a dynamic object and allows a collision edge to be shifted. In other words, in addition to the previously described all-direction risk analysis (case #1), the risk may be analyzed by shifting the estimated position by the distance to the edge in the movement direction, considering the edge of the dynamic object (case #2).

Through the implementation and performance evaluation of a minimum viable product capable of vehicle-dynamic object interaction, a function may be added in an ego vehicle to detect pedestrians beyond parked vehicles and provide alerts. This enables preemptive detection of dynamic objects in various blind spot scenarios and provides risk alerts.

What is claimed is:

1. A method for warning of a collision risk with a dynamic object in all directions around an ego vehicle, the method comprising:
determining the collision risk in real time, by a vehicle collision module, based on driving information of the ego vehicle, a position of the dynamic object, a speed of the dynamic object, and turning information of the ego vehicle,
wherein the collision risk is estimated in real time using a collision probability density function and a collision probability area, based on a time delay.

2. The method of claim 1, wherein the collision risk is determined in real time based on an initial position of the ego vehicle and the dynamic object measured by UWB (ultra-wideband) sensors installed in the ego vehicle, and a relative position over time.

3. The method of claim 1, wherein the turning information of the ego vehicle includes a steering angle based on an Ackermann model.

4. The method of claim 1, wherein the estimated collision risk is further based on a braking distance of the ego vehicle, and the braking distance is a quadratic function of a speed of the ego vehicle.

5. The method of claim 1, wherein the position of the dynamic object and the speed of the dynamic object are estimated based on a Kalman filter.

6. The method of claim 5, wherein a data-drop compensation of the dynamic object is based on an action radius of the dynamic object and a maximum speed limit of the dynamic object.

7. The method of claim 1, wherein a distance from the center of the dynamic object to an edge of the dynamic object is shifted in the collision probability density function, based on a width of the dynamic object and a length of the dynamic object.

8. The method of claim 1, wherein the time delay includes a communication delay or a driver delay.

9. The method of claim 1, further comprising displaying a warning to an occupant of the ego vehicle based on the determined collision risk.

10. The method of claim 9, wherein the warning includes a message or image displayed to the occupant via an HUD (Head-Up Display), an AVN (Audio, Video, Navigation) device, or an augmented reality device.

11. The method of claim 10, wherein the image includes a direction and a distance of the dynamic object from the ego vehicle using an indicator and an arrow, wherein the arrow points to a current position of the dynamic object, and wherein the distance between the ego vehicle and the dynamic object is represented by varying colors of the arrow based on the distance between the ego vehicle and the dynamic object.

12. A system for warning of a collision risk with a dynamic object in all directions around an ego vehicle, the system comprising:
a positioning sensor installed in the ego vehicle and configured to sense a position of the ego vehicle and the dynamic object,
wherein the collision risk is estimated in real time using the positioning sensor by incorporating vehicle turning information into driving information of the ego vehicle and a position of the dynamic object and a speed of the dynamic object, wherein the collision risk is estimated in real time using a collision probability density function and a collision probability area, based on a time delay.

13. The system of claim 12, wherein the positioning sensor is a UWB (ultra-wideband) sensor.

14. The system of claim 12, wherein the estimated collision risk is further based on a braking distance of the ego vehicle, and the braking distance is a quadratic function of a speed of the ego vehicle.

15. The system of claim 12, further comprising a vehicle control module configured to control the ego vehicle based on the estimated collision risk.

16. The system of claim 12, further comprising an HUD (Head-Up Display), an AVN (Audio, Video, Navigation) device, or an augmented reality device configured to display a warning to an occupant of the ego vehicle based on the estimated collision risk.
